(19) United States
(12) Patent Application Publication
(10) Pub. No.: US 2021/0112305 A1
(43) Pub. Date: Apr. 15, 2021

(54) VIDEO PIRACY SOURCE IDENTIFICATION METHOD AND SYSTEM USING REAL TIME INTEGRATION OF VERIFIED PERSONAL IDENTITY

(71) Applicants: Noufal KP, Kerala (IN); MOHAMMED ASHRAF V.K, Kerala (IN)

(72) Inventors: Noufal KP, Kerala (IN); MOHAMMED ASHRAF V.K, Kerala (IN)

(21) Appl. No.: 16/194,295

(22) Filed: Nov. 17, 2018

(30) Foreign Application Priority Data
Sep. 15, 2018 (IN) 201841034833

(51) Int. Cl. H04N 21/441; H04N 21/8355; H04N 21/8358; H04N 21/258; H04N 21/262

(52) U.S. Cl. CPC H04N 21/441; H04N 21/8355; H04N 21/262; H04N 21/25875; H04N 21/8358

(57) ABSTRACT

The invention relates to a method facilitating the real time integration and exhibition of verified personal identity of the user like Mobile Number on all movie frames without disrupting the viewing experience in the form of watermark or text display using backend rendering techniques, front end overlay methods in different combinations with random placements at random intervals to make it difficult to mask the personal information by any means while doing any kind of copying and is applicable to streaming videos to identify the source of piracy. The method comprises of the following steps: receiving the user data such as mobile number and name, verifying the identity of the user by providing secured access to the server with the generation of one time password (OTP) to the provided mobile number, selecting the video content from the collection library on request of the user, integrating and exhibiting the user detail such as mobile number and name on all frames of the video content randomly in various forms such as watermark, text display etc., delivering the requested video content to the user along with the overlaid details, wherein the user can view the content through video content viewer provided along with the overlaid details on the content.

### TECHNICAL FIELD

This invention relates, in general, to identify the source of video piracy and, more specifically, to minimize the video from being copied and spread it over the internet or in any other media at its optimum level as this method will tell the content owner about the personal identification of the sources who have done the piracy. This invention implement a new and efficient method, system and algorithm for integrating and exhibiting the verified personal identity like Mobile Number of a user on all movie frames using backend rendering techniques, using front end overlay methods in different combinations with random placements at random intervals making it difficult to mask the personal information by any means while doing any kind of copying.

### BACKGROUND OF THE INVENTION

Streaming online movies are the trend of the hour! All major players in this industry are doing several kind of application for playing a movie online and make it available to the public user. Despite of massive advancements over the past two decades, there were hurdles in the industry like bandwidth limitations, latency issues, compatibility challenges etc, preventing viewers from experiencing seamless video streaming. The good news now is that today's technology has made it possible to overcome these issues and deliver high-quality streaming video to users anytime, anywhere. However, the most challenging problem of piracy still remains. Even after the advancement of technology, still there is no absolute solution to protect the online movies/videos from being stolen.

If a video can be viewed on a computer or mobile, it can be stolen. Several downloading protection mechanism have been introduced but nothing can be done on stealing video using tools like stream capture/screen recording tools and moreover there is no absolute way to protect a video from being copied if somebody set up a video camera and point it at a computer monitor and record it.

Other than DVD/Bluray, there are many online content providers in the market like Netflix, Hotstar, Amazon Prime etc. However, none of their content is secure. There are many techniques used by these content providers to secure their content from copying illegally. However, none of the method is fool proof and successful.

The contents that are illegally copied can be uploaded in any public domain like YouTube, facebook, etc because the unauthorized copying personnel are not scared of revealing their identity since finding the source of video piracy is very difficult or to certain extend it is even impossible.

The content that are illegally copied are also available under various release tags in the dark web and various torrent sites. Some of the tags are as follows.
WEB-DL—usually used when the DRM is broken and the entire original content is downloaded to the hacker's machine. Very high quality (even 4K) is guaranteed for such videos.
WEBRip—used when the content is captured using screen capture programs or when by using a HDMI Splitter and TV Capture Card. High quality is guaranteed when the network is good.
Web—usually used for scenes, or by using external devices.
DVDRip—when the movie is copied from a DVD and released in the web.
BlurayRip—when the movie is copied from a bluray and released in the web.

The illegally copied video contents are available easily in the public domains, torrent and dark weband finding out the source of piracy is very difficult to track the culprit. Therefore, there is a need for developing a new system to minimize the video piracy by inventing a new method and system for identifying the personnel using integration of verified personal identity of the person into the streaming video who is doing the video piracy.

### SUMMARY OF THE INVENTION

### Project Objectives

The objectives of the present invention are listed below. Delivering these objectives will deliver the expected benefits of the application.

Main Objectives
To implement a new and efficient method, system and algorithm for integrating and exhibiting (like watermarking) the verified personal identity of users on all movie frames using backend rendering techniques, using front end overlay methods in different combinations with random placements at random intervals making it difficult to mask the personal information by any means while doing any kind of copying.
To implement a web-based application platform to stream new movie releases securely without the fear of piracy.
To implement a mobile app which can be used by users to watch movies on their mobile devices which are not possible to copy without revealing their personal identity.
To provide a mechanism for user to register using their personal phone number which can be validated using OTP, automated calls or any other channel of verification.

General Objective
To allow content providers to upload original video content via the platform for release.
To allow content providers to provide the content via offline mechanism that can be used for future releases in the platform.
To allow a user to book ticket for online viewing by paying the subscription fee using any payment mechanism provided in the platform.
To provide a flexible pricing option which can even support dynamic mode based on hit, super hit, ageetc of the movie.
To provide a subscription time window (eg. 24 hours) to watch the movie subscribed.
To notify the user using SMS/Email/Other notification channels when the movie is ready to be watched online.
To provide a general infrastructure of movie streaming platform that can be scaled to any number of concurrent users.
To provide standard community functionality for users to “like”, “review/rate” movies after watching it including sharing reviews on popular social media networks like facebook, twitter etc.
To achieve high security on content that need to be streamed and not to allow any malpractice to copy it from the servers.
To achieve high performance of the platform even for large count of users.
To recommend content based on the user's interests using his past viewing history.
To support logging of errors/warnings/exceptions, auditing all the user actions and data modifications, tracking all the analytics and statistics data during the application execution (in all the modules).

Administrative Objectives
To schedule a movie release with the number of “online” seats.
To implement regular administrative and management actions on user accounts, content moderation, videos' options etc.

Reporting Objectives
To automatically acquire the analytics related to viewership; and to persist that data in database.
To check the daily/weekly/monthly/lifetime viewership details filtered by movies.
To implement real time reports with “live” statistics and analytics information related to the movies in progress.
To support exporting reports in various data formats.

### BRIEF DESCRIPTION OF DRAWINGS

For a more complete understanding of the present invention, reference is now made to the following descriptions taken in conjunction with the accompanying drawing, in which

FIG. 1 depicts a system for protecting video piracy.

FIG. 2 depicts a flowchart/process for protecting video piracy.

### DETAILED DESCRIPTION OF THE INVENTION

In the following detailed description, reference is made to the accompanying drawing, which form a part hereof. The illustrative embodiments described in the detailed description and drawings are not meant to be limiting. Other embodiments may be utilized, and other changes may be made, without departing from the spirit or scope of the subject matter presented here.

It will be understood that this disclosure is not limited to the particular systems, and methodologies described, as there can be multiple possible embodiments of the present disclosure which are not expressly illustrated in the present disclosure. It is also to be understood that the terminology used in the description is for the purpose of describing the particular versions or embodiments only, and is not intended to limit the scope of the present disclosure.

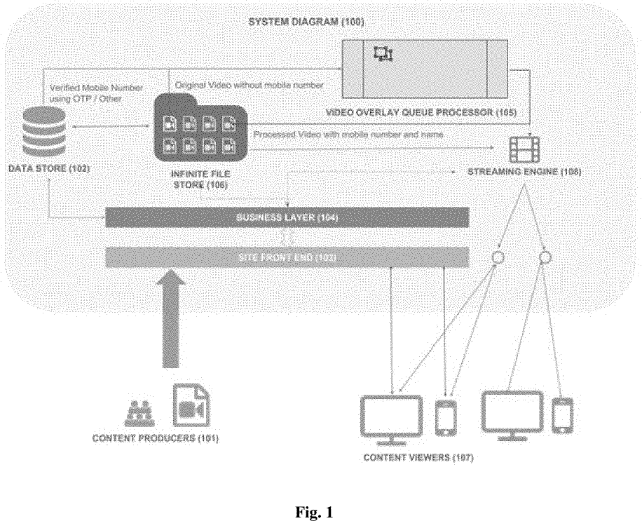

FIG. 1 illustrates a system 100 in which the content producers 101 provide their contents to a data store 102 via site front end 103 and business layer 104. A video overlay queue processor 105 is connected to an infinite file store 106 and the data store for receiving original video content and for sending the overlaid video content. The content viewers/users 107 are connected to the data store 102 via site front end 103 and business layer 104 for sharing their details. The streaming engine 108 receives the content from the infinite file store 106 and sends the content to the content viewers 107.

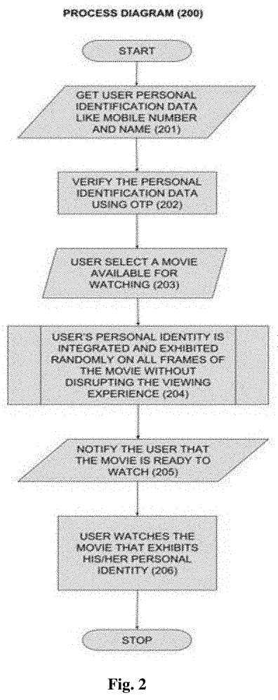

FIG. 2 illustrates a process 200 that facilitates the integration of personal details with in the video content as overlays and overwrites. At 201, the user data such as mobile number and name are received. At 202, the user is given secured access to the server with the generation of one time password (OTP). At 203, the user can select the video content of his own choice from the collection library. At 204, the user detail such as mobile number and name are integrated and exhibited on all frames of the video contents randomly without disrupting the viewing experience. At 205, the user will be notified that his personalized movie can be watched. At 206, the user can view the content with the help of the content viewers.

The above disclosed aspects of the video piracy source identification method and system using real time integration of verified personal identity may be implemented by a computer readable code on a computer readable recording medium.

In the description above, although all of the components of the aspects of the present disclosure may have been explained as assembled or operatively connected as a unit, the present disclosure is not intended to limit itself to such aspects. Rather, within the objective scope of the present disclosure, the respective components may be selectively and operatively combined in any numbers. Every one of the components may be also implemented by itself in hardware while the respective ones can be combined in part or as a whole selectively and implemented in a computer program having program modules for executing functions of the hardware equivalents. Codes or code segments to constitute such a program may be easily deduced by a person skilled in the art. The computer program may be stored in computer readable media, which in operation can realize the aspects of the present disclosure. As the computer readable media, the candidates include magnetic recording media, optical recording media, and carrier wave media.

In addition, terms like ‘include’, ‘comprise’, and ‘have’ should be interpreted in default as inclusive or open rather than exclusive or closed unless expressly defined to the contrary. All the terms that are technical, scientific or otherwise agree with the meanings as understood by a person skilled in the art unless defined to the contrary. Common terms as found in dictionaries should be interpreted in the context of the related technical writings not too ideally or impractically unless the present disclosure expressly defines them so.

Although exemplary aspects of the present disclosure have been described for illustrative purposes, those skilled in the art will appreciate that various modifications, additions and substitutions are possible, without departing from essential characteristics of the disclosure. Therefore, exemplary aspects of the present disclosure have not been described for limiting purposes.

Accordingly, the scope of the disclosure is not to be limited by the above aspects but by the claims and the equivalents thereof.

We claim:

1. A system facilitating the real time integration and exhibition of verified personal identity of the user like Mobile Number ,on all movie frames without disrupting the viewing experience ,in the form of watermark or text display using backend rendering techniques, front end overlay methods in different combinations with random placements at random intervals to make it difficult to mask the personal information by any means while doing any kind of copying, comprising:
Means for receiving the user data such as mobile number and name.
Means for providing secured access to the video with the generation of one time password (OTP).
Means for selecting the video content from the collection library on request of the user.
Means for integrating and exhibiting the user detail such as mobile number and name on all frames of the video contents randomly in various forms such as watermarking
Means for delivering the requested video content to the user along with the integrated personal identity, wherein the user can view the content through video content viewer along with the overlaid details on the content.

2. The system as claimed in claim 1, wherein content producer can upload original content via the platform which will be stored in a secured server.

3. The system as claimed in claim 1, wherein the content producer can configure the release dates, pricing, etc and change the status of the movie to “Ready to release” status.

4. The system as claimed in claim 1, wherein “Ready to Release” movies will be available for booking to the users, provided there are enough open seats available in the platform.

5. The system as claimed in claim 1, wherein a verified user can book the movie of his interest.

6. The system as claimed in claim 1, wherein the queue processor integrates the personal identity of the user into the video content and sends a “ready to watch” message to the user.

7. The system as claimed in claim 1, wherein the user will have a fixed time window to watch the content after which the content will be deleted.

8. The system as claimed in claim 1, wherein the user can rate the movie and write comments which needs to be approved by the admin.

9. A method facilitating the real time integration and exhibition of verified personal identity of the user like Mobile Number on all movie frames in the form of watermark or text display using backend rendering techniques, front end overlay methods in different combinations with random placements at random intervals to make it difficult to mask the personal information by any means while doing any kind of copying, comprising:
Receiving the user data such as mobile number and name.
Providing secured access to the server with the generation of one time password (OTP).
Selecting the video content from the collection library on request of the user.
Integrating and exhibiting the user detail such as mobile number and name on all frames of the video contents randomly in various forms such as watermark, text display
Delivering the requested video content to the user along with the overlaid details.
Wherein the user can view the content through video content viewer along with the over laid details on the content.

10. The methods as claimed in claim 9, wherein content producer can upload original content via the platform which will be stored in a secured server.

11. The methods as claimed in claim 9, wherein the content producer can configure the release dates, pricing, etc and change the status of the movie to “Ready to release” status.

12. The methods as claimed in claim 9, wherein “Ready to Release” movies will be available for booking to the users, provided there are enough open seats available in the platform.

13. The methods as claimed in claim 9, wherein a verified user can book the movie of his interest.

14. The methods as claimed in claim 9, wherein the queue processor integrates the personal identity of the user into the video content and sends a “ready to watch” message to the user.

15. The methods as claimed in claim 9, wherein the user will have a fixed time window to watch the content after which the content will be deleted.

16. The methods as claimed in claim 9, wherein the user can rate the movie and write comments which needs to be approved by the admin.

17. A non-transitory computer readable medium storing a computer program comprising functions of:
Receiving the user data such as mobile number and name.
Providing secured access to the server with the generation of one time password (OTP).
Selecting the video content from the collection library on request of the user.
Integrating and exhibiting the user detail such as mobile number and name on all frames of the video contents randomly in various forms such as watermark, text display
Delivering the requested video content to the user along with the overlaid details.
Wherein the user can view the content through video content viewer along with the over laid details on the content.

18. The non-transitory computer readable medium as claimed in claim 17, wherein content producer can upload original content via the platform which will be stored in a secured server.

19. The non-transitory computer readable medium as claimed in claim 17, wherein the content producer can configure the release dates, pricing, etc and change the status of the movie to “Ready to release” status.

20. The non-transitory computer readable medium as claimed in claim 17, wherein “Ready to Release” movies will be available for booking to the users, provided there are enough open seats available in the platform.

21. The non-transitory computer readable medium as claimed in claim 17, wherein a verified user can book the movie of his interest.

22. The non-transitory computer readable medium as claimed in claim 17, wherein the queue processor integrates the personal identity of the user into the video content and sends a “ready to watch” message to the user.

23. The non-transitory computer readable medium as claimed in claim 17, wherein the user will have a fixed time window to watch the content after which the content will be deleted.

24. The non-transitory computer readable medium as claimed in claim 17, wherein the user can rate the movie and write comments which needs to be approved by the admin.
